(19) United States
(12) Patent Application Publication
(10) Pub. No.: US 2025/0332934 A1
(43) Pub. Date: Oct. 30, 2025

(54) AUTOMATIC CHARGING DEVICE

(71) Applicant: GUOCHUANG INNOVATION CENTER OF MOBILE ENERGY (JIANGSU) CO., LTD., Jiangsu (CN)

(72) Inventors: Bo JIANG, Jiangsu (CN); Chengfei ZHANG, Jiangsu (CN); Longlong CHEN, Jiangsu (CN); Lixiong XU, Jiangsu (CN)

(73) Assignee: GUOCHUANG INNOVATION CENTER OF MOBILE ENERGY (JIANGSU) CO., LTD., Jiangsu (CN)

(21) Appl. No.: 18/867,008

(22) PCT Filed: Jun. 16, 2023
(86) PCT No.: PCT/CN2023/100663

§ 371 Date: Nov. 19, 2024

(30) Foreign Application Priority Data
Jun. 28, 2022 (CN) 202221653584.9

(51) Int. Cl. B60L 53/16; B60L 53/18; B60L 53/35

(52) U.S. Cl. CPC B60L 53/16; B60L 53/35; B60L 53/18; B60L 2200/26

(57) ABSTRACT

An automatic charging device is particularly suitable for automatically charging a heavy rail tractor, including a box body; a robotic arm, the robotic arm including a fixed arm and a retractable arm, the fixed arm is fitted in the box body, a driving screw assembly is fitted between the fixed arm and the retractable arm, and the retractable arm can be driven by the driving screw assembly to extend and retract relative to the fixed arm; a flexible unit; and a charging part, wherein the charging part is fitted to a retractable end of the retractable arm by means of the flexible unit, the charging part may be driven by the retractable arm to extend from the box body to implement charging, and after the charging is completed, the charging part may retract into the box body.

### TECHNICAL FIELD

The present disclosure relates to the charging field, particularly to an automatic charging device, which is especially suitable for automatic charging of heavy rail traction vehicles.

### DESCRIPTION OF RELATED ART

Under the major trend of electrification, more and more special transportation vehicles including autonomous vehicles, port AGVs and container trucks, electric mining trucks, airport vehicles, etc. are equipped with energy storage batteries of extremely high energy density. The energy storage battery undergoes a process of repeated charging and discharging during use, therefore the demand for charging equipment, especially automatic and intelligent charging equipment, is increasing. Compared with charging piles for civilian passenger vehicles, the development of automatic charging in the field of special transportation in China is currently slower, with poor equipment performance indicators and reliability issues persisting. Some areas even have a blank in this field and can only rely on imported foreign equipment, which is expensive. Therefore, the development of automatic docking and charging equipment for new energy transportation equipment has become an urgent problem to be solved.

Unlike civilian charging piles, new energy special transportation vehicles have higher requirements for equipment working environment, protection performance, and automation level. For example, the document with application number CN202121308409.1 discloses an automatic docking charging device, which is used for automatic charging of traction vehicles in railway transportation. The document specifically discloses: the automatic docking charging device is used to dock with the power receiving box of the device to be charged; the power receiving box includes a first docking component and a second docking component: the automatic docking charging device includes a support frame, an retractable assembly, a lifting assembly, a charging assembly, a third docking component and a fourth docking component; wherein, the retractable assembly is set on the support frame and is extendable along the first direction X; the lifting assembly is set at the output end of the retractable assembly and may lift along the second direction Z; the charging assembly is set at the output end of the lifting assembly, and the charging assembly is used to dock with the charging terminal of the power receiving box; the automatic docking charging device also includes a guide seat; the guide seat is provided with a guide groove; the guide seat is set at the output end of the lifting assembly, the guide rod is horizontally set, the guide rod has a docking position inserted into the guide groove and a separated position separated from the guide groove, the fourth docking component is set at the bottom of the guide groove, that is, when the guide rod is inserted into the bottom of the guide groove to trigger the fourth docking component. This arrangement allows the guide rod and guide groove to dock, which can improve the stability of the charging assembly and avoid the charging assembly moving up and down.

The above-mentioned automatic docking charging device requires two motion mechanisms, a lifting assembly and a retractable assembly, to achieve the movement and positioning of the charging assembly in the vertical and horizontal directions to complete automatic charging. The retractable assembly adopts a scissor structure as the horizontal motion mechanism. Due to the insufficient rigidity of the scissor structure itself and the large self-weight and weight of the lifting assembly, it is necessary to design a horizontal guiding mechanism that can bear a large load. The lifting assembly uses a counterweight block, which is heavy and can only move up and down without left and right movement adjustment. Therefore, the design of the motion mechanisms in two directions, the lifting assembly and the retractable assembly, is complex, resulting in a bulky and unreliable overall machine with high manufacturing costs.

### SUMMARY

To solve the technical problem in the existing technology where the retractable assembly of the charging device uses a scissor structure as the horizontal motion mechanism, which has large gravity and insufficient rigidity, easily causing the whole machine to be bulky and unreliable in operation, the present disclosure provides an automatic charging device that solves the aforementioned technical problems. The technical solution of the present disclosure is as follows.

An automatic charging device, including:
A box body:
A robotic arm, wherein the robotic arm includes a fixed arm and a retractable arm. The fixed arm is assembled in the box body, a driving screw assembly is assembled between the fixed arm and the retractable arm, and the retractable arm may perform a retractable movement relative to the fixed arm under the drive of the driving screw assembly;
A flexible unit;
A charging part, wherein the charging part is assembled at the retractable end of the retractable arm through the flexible unit. Under the drive of the retractable arm, the charging part is extendable out from the box body for charging; after charging is completed, the charging part may retract into the box body.

The automatic charging device of the present disclosure, by setting up a robotic arm driven by a driving screw assembly, compared to the scissor structure in the existing technology, the driving screw assembly structure is lightweight, compact, and has high rigidity, with low cost. The charging part is assembled at the retractable end of the retractable arm through the flexible unit, which may facilitate automatic position adjustment of the charging part for accurate insertion with the docking structure. The charging part, flexible unit, and robotic arm may be stored in the box body, during operation, the robotic arm drives the charging part to extend from the box body, providing good protection and adaptability for outdoor and complex environment operations.

According to an embodiment of the present disclosure, the charging part includes a guide component and charging electrodes, both the guide component and the charging electrodes are assembled on a mounting plate, and the guide component is assembled in the middle part of the mounting plate. The charging electrodes include a positive electrode and a negative electrode, the positive electrode and the negative electrode are located on two sides of the guide component respectively.

According to an embodiment of the present disclosure, the charging electrodes further include a signal electrode and a neutral electrode. The signal electrode and the neutral electrode are located on two sides of the guide component respectively, the positive electrode and the negative electrode are diagonally arranged.

According to an embodiment of the present disclosure, the guide component is assembled to be linearly slidable through a first connecting rod. A first elastic component is fitted on the first connecting rod, a contact pressure detection switch is disposed between the guide component and the mounting plate. When the contact pressure detection switch is triggered, the robotic arm stops extending.

According to an embodiment of the present disclosure, the charging electrodes are assembled on an electrode plate. The electrode plate is assembled to be linearly slidable on the mounting plate through a second connecting rod. A second elastic component is fitted on the second connecting rod. A contact pressure detection structure is disposed between the electrode plate and the mounting plate to detect the charging pressure.

According to an embodiment of the present disclosure, the contact pressure detection structure includes a pressure sensor and a contact component. The pressure sensor is assembled on the electrode plate, and the contact component is elastically assembled on the mounting plate.

According to an embodiment of the present disclosure, a contact limit detection switch is also disposed between the electrode plate and the mounting plate. When the contact limit detection switch is triggered, the robotic arm stops extending.

According to an embodiment of the present disclosure, a sliding assembly is also disposed between the fixed arm and the retractable arm, and the sliding assembly is set parallel to the driving screw assembly.

According to an embodiment of the present disclosure, the box body is assembled through a bottom adjustment frame. The bottom adjustment frame may adjust the position of the box body along the vertical direction and horizontal direction. The horizontal direction is perpendicular to the retracting direction of the robotic arm.

According to an embodiment of the present disclosure, the flexible unit includes a sliding platform and a universal adjustment seat. The universal adjustment seat is slidably assembled on the robotic arm through the sliding platform. The charging part is assembled on the universal adjustment seat.

Based on the above technical solution, the technical effects that may be achieved by the present disclosure are:

In the automatic charging device of the present disclosure, by setting the robotic arm to be driven by a driving screw assembly, compared with the scissor structure in the existing technology, the driving screw assembly structure is lightweight, compact and has high rigidity, with low cost; the charging part is assembled on the retractable end of the retractable arm through a flexible unit, which may facilitate automatic position adjustment of the charging part for accurate docking with the vehicle-end power receiving device. The charging part, the flexible unit and the robotic arm may be stored inside the box body. During operation, the robotic arm drives the charging part to extend out from the box body, providing good protection and adaptability for outdoor and complex environment operations.

In the automatic charging device of the present disclosure, the charging part includes a guide component and charging electrodes. The provision of the guide component may be used for guiding and positioning before charging, ensuring accurate docking between the charging electrodes and the vehicle-end power receiving device. Setting the guide component to be assembled in the middle, with the positive electrode and negative electrode of the charging electrodes located on two sides of the guide component, may separate the positive electrode and negative electrode through the guide component, increasing the distance between the two to ensure safety. Further setting the positive electrode and negative electrode on the diagonal of a quadrilateral formed by four electrodes maximizes the distance between the positive electrode and negative electrode to the greatest extent, ensuring charging safety. As the automatic charging device of the present disclosure is used for charging new energy special transportation vehicles (such as traction vehicles for railway transportation) with high charging voltage, if the distance between the positive electrode and negative electrode is too short, it is easy to cause short circuit, and arcing may occur during the plugging and unplugging process. By separating the positive electrode and negative electrode with the guide component, it not only does not affect the normal use of guiding and charging functions, but also optimizes the layout to ensure charging safety.

In the automatic charging device of the present disclosure, the guide component is assembled to be linearly slidable through a first connecting rod. A first elastic component is fitted on the first connecting rod, and a contact pressure detection switch is provided. The first elastic component may provide elastic force to the guide component to prevent retraction of the guide component. If the deviation between the vehicle-end power receiving device and the actual position of the charging part is too large, causing the guide component to be located on the periphery of the vehicle-end guide port, the robotic arm will drive the charging part and the guide component to forcibly feed, until overcoming the elastic force of the first elastic component and triggering the contact pressure detection switch, the robotic arm stops feeding, preventing further structural damage.

The automatic charging device of the present disclosure sets the assembly method of the charging electrodes, and correspondingly sets a contact pressure detection structure, which facilitates the detection of charging pressure, ensuring that charging is performed only after the charging pressure between the charging electrodes and the vehicle-end power receiving device reaches the required pressure, thus ensuring the stability and safety of charging. A contact limit detection switch is also set between the electrode plate and the mounting plate. If the contact pressure detection structure fails, after reaching the charging pressure, the charging part will continue to feed a small displacement until the charging part touches the contact limit detection switch. When the contact limit detection switch is triggered, the contact limit detection switch sends an electrical signal to stop the motor of the robotic arm.

In the automatic charging device of the present disclosure, a sliding assembly is also set between the fixed arm and the retractable arm, with the sliding assembly set parallel to the driving screw assembly, thus the sliding assembly may provide support and guidance for the retractable arm, further ensuring stable movement of the retractable arm relative to the fixed arm. The box body is fixedly assembled through a bottom adjustment frame, which may adjust the position of the box body in horizontal and vertical directions, with the horizontal direction perpendicular to the retracting direction of the robotic arm, thus the position of the retractable arm of the robotic arm may be adjusted relative to the ground along three directions of X, Y, and Z, meeting the adjustment needs of the charging part position in various directions. The flexible unit includes a sliding platform and a universal adjustment seat, with self-adaptive adjustment functions for angle and position, preventing jamming during guidance when there is an angle deviation between the ground-end charging part and the vehicle-end power receiving device, thereby avoid docking and charging failure.

### BRIEF DESCRIPTION OF THE DRAWINGS

FIG. 1 is a schematic diagram of the overall structure of the automatic charging device of the present disclosure.

FIG. 2 is a schematic diagram of the overall structure of the automatic charging device from another perspective.

FIG. 3 is a schematic diagram of the structure where the charging part is assembled on the robotic arm through the flexible unit.

FIG. 4 is a schematic diagram of the structure of the robotic arm.

FIG. 5 is a schematic diagram of the structure of the fixed arm.

FIG. 6 is a schematic diagram of the structure of the retractable arm.

FIG. 7 is a schematic diagram of the structure of the first cable fixing rack.

FIG. 8 is a schematic diagram of the structure of the flexible unit.

FIG. 9 is a schematic diagram of the structure of the sliding platform.

FIG. 10 is a schematic diagram of the structure of the universal adjustment seat.

FIG. 11 is a schematic diagram of the structure of the charging part.

FIG. 12 is a schematic diagram of the structure of the guide component assembled on the mounting plate.

FIG. 13 is a schematic diagram of the structure of the charging electrode assembled on the mounting plate.

In the figures: 1—box body; 11—electric sliding door; 2—robotic arm; 21—fixed arm: 211—positive limit stroke switch; 212—negative limit stroke switch; 22—retractable arm; 221—first cable fixing rack; 2211—mounting seat; 2212—shaft; 2213—cable fixing seat; 2214—third elastic component; 2215—pressure cover; 222—limit pressing component; 23—driving screw assembly; 231—lead screw; 232—nut; 24—sliding assembly: 241—first slide rail; 242—first slider; 3—flexible unit; 31—sliding platform; 311—first panel; 3111—second slide rail; 3112—first connecting shaft; 3113—first spring component: 312—second panel; 3121—second slider; 3122—third slide rail; 3123—second connecting shaft; 3124—second spring component; 3125—third slider; 32—universal adjustment seat; 321—rear end panel: 3211—connecting portion; 3212—fourth slider; 322—intermediate; 323—front end panel; 324—tension spring: 4—charging part: 41—guide component: 411—first connecting rod; 412—first linear bearing; 413—first elastic component; 414—contact pressure detection switch; 415—guide pressing component: 42—charging electrode; 421—electrode plate; 4211—second cable fixing rack; 422—insulator; 423—second connecting rod; 424—second linear bearing: 425—second elastic component: 426—contact pressure detection structure; 4261—pressure sensor; 4262—contact component; 427—contact limit detection switch; 428—charging pressing component: 43—mounting plate; 431—mounting frame; 5—bottom adjustment frame; 6—wireless communication module; 7—circuit box; 8—alarm; 9—cable; 20—vehicle—end power receiving device: 201—guide groove: 202—copper busbar; 100—foundation.

### DESCRIPTION OF THE EMBODIMENTS

The following description will clearly and completely describe the technical solutions in the embodiments of the present disclosure in conjunction with the accompanying drawings of the embodiments of the present disclosure. Clearly, the described embodiments are only a part of the embodiments of the present disclosure, not based on the embodiments in the present disclosure, all other embodiments obtained by those skilled in the art without creative labor are within the scope of protection of the present disclosure.

It should be noted that the terms used here are only for describing specific implementation methods, and are not intended to limit the example embodiments according to the present disclosure. As used herein, unless explicitly indicated otherwise by the context, singular forms are also intended to include plural forms. Furthermore, it should be understood that when the terms “comprise” and/or “include” are used in this specification, they indicate the presence of features, steps, operations, devices, assemblies and/or combinations thereof.

Unless otherwise specifically stated, the relative arrangement, numerical expressions and values of the assemblies and steps described in these embodiments do not limit the scope of the present disclosure. At the same time, it should be understood that, for the convenience of description, the dimensions of various parts shown in the drawings are not drawn according to the actual proportional relationship. For technologies, methods and devices known to those skilled in the relevant field, detailed discussion may not be made, but in appropriate circumstances, the said technologies, methods and devices should be regarded as part of the specification. In all examples shown and discussed here, any specific values should be interpreted as merely exemplary and not as limitations. Therefore, other examples of example embodiments may have different values. It should be noted that similar numerals and letters in the following drawings indicate similar items, so once an item is defined in one drawing, it does not need to be further discussed in subsequent drawings.

In the description of the present disclosure, it should be understood that directional terms such as “front, back, up, down, left, right”, “horizontal, vertical, perpendicular, horizontal” and “top, bottom” and other directional or positional relationships indicated are usually based on the orientation or positional relationship shown in the drawings, and are only for the purpose of facilitating the description of the present disclosure and simplifying the description. In the absence of contrary statements, these directional terms do not indicate or imply that the referred device or element must have a specific orientation or be constructed and operated in a specific orientation, and therefore cannot be understood as a limitation on the scope of protection of the present disclosure; the directional terms “inner, outer” refer to the inside and outside of the outline of the assemblies themselves.

For the convenience of description, spatial relative terms may be used here, such as “on . . . ”, “above . . . ”, “on the surface of . . . ”, “over . . . ” etc., to describe the spatial relationship between one device or feature and other devices or features as shown in the figures. It should be understood that the spatial relative terms are intended to encompass different orientations of the device in use or operation in addition to the orientation described in the figures. For example, if the device in the figure is inverted, the device described as “above other devices or structures” or “on other devices or structures” will then be positioned “below other devices or structures” or “under other devices or structures”. Thus, the example term “above . . . ” may include both “over . . . ” and “below . . . ” orientations. The device may also be positioned in other different ways (rotated 90 degrees or in other orientations), and the spatial relative descriptions used here are interpreted accordingly.

In addition, it should be noted that the use of words such as “first”, “second” to define parts is merely for the convenience of distinguishing the corresponding parts. Unless otherwise stated, these words have no special meaning and therefore cannot be understood as a limitation on the scope of protection of the present disclosure.

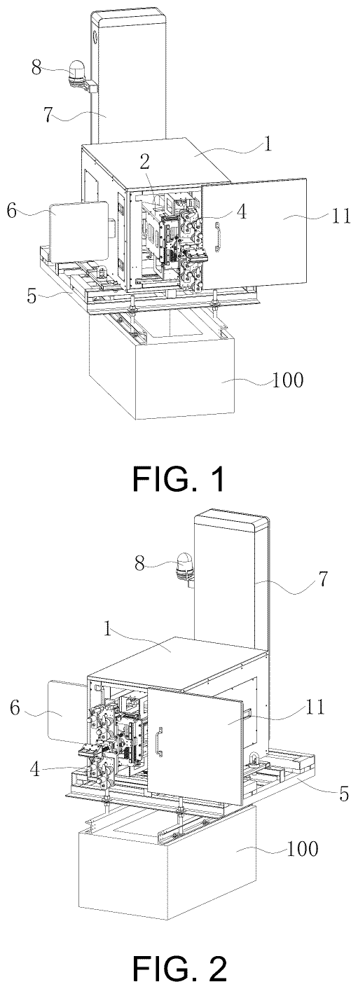

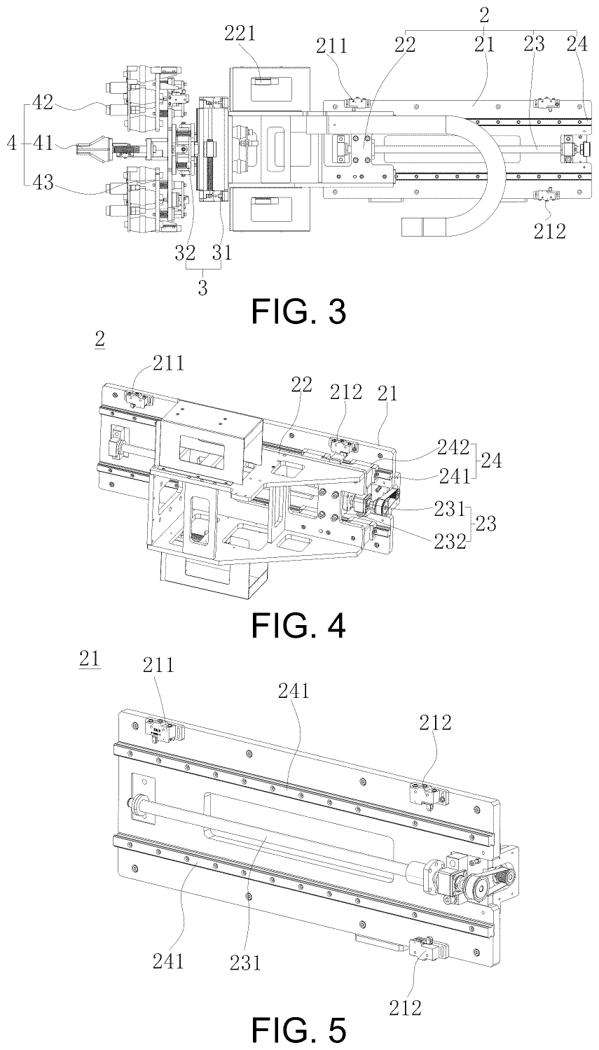

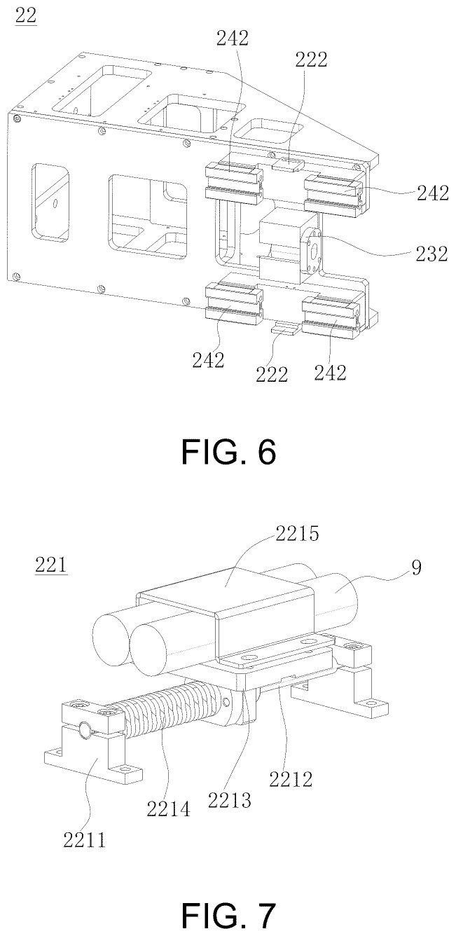

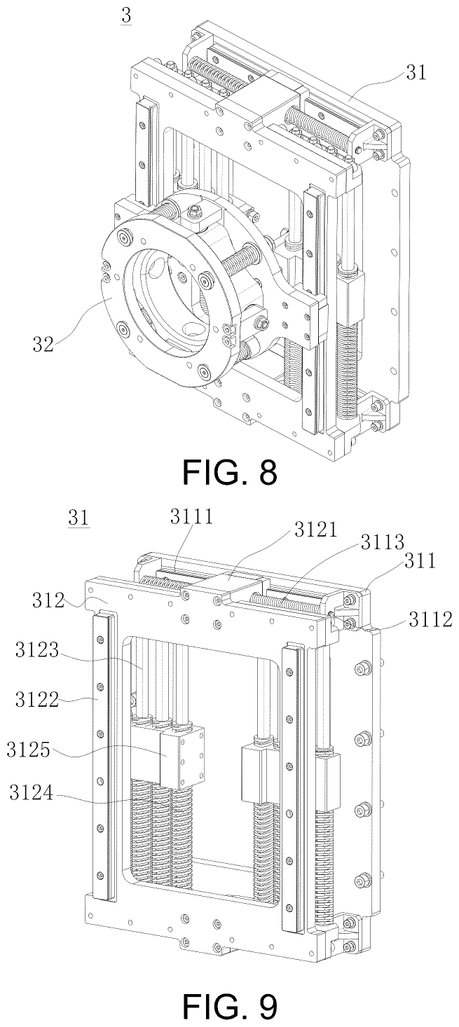

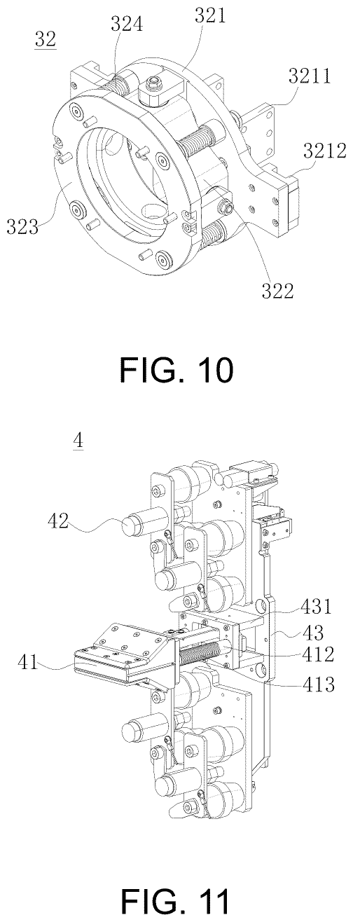

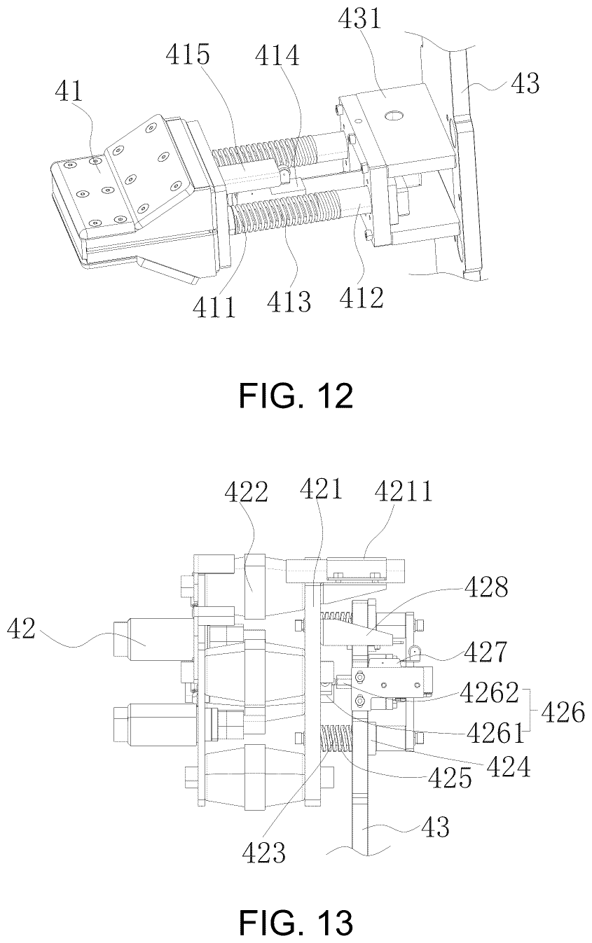

As shown in FIG. 1 to FIG. 13, this embodiment provides an automatic charging device, including a box body 1, a robotic arm 2 and a charging part 4. The charging part 4 is assembled on the retractable end of the robotic arm 2 through a flexible unit 3. The robotic arm 2 is assembled inside the box body 1. During operation, the robotic arm 2 may drive the charging part 4 to extend horizontally outward from inside the box body 1. The charging part 4 may dock with the vehicle-end power receiving device 20 for charging. After charging is completed, the robotic arm 2 may drive the charging part 4 to retract into the box body 1, fully accommodated inside the box body 1.

The box body 1 may be a square box body with an opening formed on a side thereof, wherein an electric sliding door 11 is assembled at the opening. The electric sliding door 11 may slide horizontally to open and close, facilitating the robotic arm 2 to drive the charging part 4 to extend and retract for charging operations.

The robotic arm 2 includes a fixed arm 21 and a retractable arm 22. The fixed arm 21 is fixedly assembled inside the box body 1, and the retractable arm 22 is retractable relative to the fixed arm 21. In this embodiment, the fixed arm 21 arm 21 is set to be fixed on the side wall of the box body 1, and a driving screw assembly 23 is assembled between the fixed arm 21 and the retractable arm 22. The retractable arm 22 extends and retracts relative to the fixed arm 21 under the drive of the driving screw assembly 23.

Specifically, the driving screw assembly 23 includes a lead screw 231 and a nut 232. The lead screw 231 is rotatably assembled on the fixed arm 21 and extends horizontally. The nut 232 is assembled on the retractable arm 22. When the lead screw 231 rotates under the drive of a motor, the lead screw 231 may drive the nut 232 to carry the retractable arm 22 to perform reciprocating linear motion along the lead screw 231.

As a preferred technical solution of this embodiment, to ensure stable extension and retraction of the retractable arm 22 along the fixed arm 21, a sliding assembly 24 is also set between the fixed arm 21 and the retractable arm 22, with the sliding assembly 24 set parallel to the driving screw assembly 23. The sliding assembly 24 includes a first slide rail 241 and a first slider 242. The first rail slide 241 is assembled on the fixed arm 21, with the extending direction of the first slide rail 241 parallel to the axis of the lead screw 231. The first slider 242 is fixed on the retractable arm 22, and the first slider 242 is slidably coupled with the first slide rail 241. Grooves are also formed on two sides of the first slide rail 241, and the first slider 242 is extendable into the grooves to prevent detachment. Conversely, the grooves may also be set on the first slider 242. In this embodiment, two sets of sliding assemblies 24 are provided, with the two sets of sliding assemblies 24 located on the upper and lower sides of the driving screw assembly 23 respectively serve as guides and supports.

As a preferred technical solution of this embodiment, to control the stroke of the retractable arm 22, stroke switch is also set on the fixed arm 21, specifically including a positive limit stroke switch 211 and a negative limit stroke switch 212. The positive limit stroke switch 211 is located at the front end of the fixed arm 21, configured to limit the maximum length of the extension of the retractable arm 22; the negative limit stroke switch 212 is located at the rear end of the fixed arm 21, configured to limit the maximum position of the retraction of the retractable arm 22. A limit pressing component 222 is fixed on the retractable arm 22, which moves with the retractable arm 22. When the limit pressing component 222 presses against the positive limit stroke switch 211 or the negative limit stroke switch 212, the positive limit stroke switch 211 or the negative limit stroke switch 212 sends a signal, and the motor stops driving.

As a preferred technical solution of this embodiment, a first cable fixing rack 221 is further set on the retractable arm 22, which may achieve active fixation of the cable 9. The first cable fixing rack 221 includes two mounting seats 2211, which are fixed on the retractable arm 22 at intervals. The two ends of the shaft 2212 are fixed on the two mounting seats 2211 respectively. The cable fixing seat 2213 is slidably assembled on the shaft 2212. A third elastic component 2214 is fitted on the shaft 2212, located between one mounting seat 2211 and the cable fixing seat 2213. The two ends of the third elastic component 2214 act on the mounting seat 2211 and the cable fixing seat 2213 respectively. A pressure cover 2215 is fixed at the upper end of the limit fixing seat 2213. The fixing seat 2213 may cooperate with the pressure cover 2215 to fix the cable 9.

The flexible unit 3 includes a sliding platform 31 and a universal adjustment seat 32. The sliding platform 31 may achieve position compensation of the charging part 4 in two directions, while the universal adjustment seat 32 may achieve angle compensation of the charging part 4, ensuring accurate docking of the charging part 4. Specifically, the sliding platform 31 includes a first panel 311 and a second panel 312, which are assembled in a stacked sliding manner. One side of the first panel 311 facing the second panel 312 is equipped with a second slide rail 3111 and a first connecting shaft 3112, with the first connecting shaft 3112 parallel to the second slide rail 3111. One side of the second panel 312 facing the first panel 311 is correspondingly equipped with a second slider 3121, which slideably cooperates with the second slide rail 3111. In the meantime, the second slider 3121 passes through the first connecting shaft 3112 and slides along the first connecting shaft 3112.

One side of the second panel 312 away from the first panel 311 is equipped with a third slide rail 3122. The second panel 312 is also equipped with a second connecting shaft 3123, which is parallel to the third slide rail 3122. A third slider 3125 is slidably assembled on the second connecting shaft 3123. A connecting portion 3211 and a fourth slider 3212 are formed on the universal adjustment seat 32. The connecting portion 3211 is fixedly connected to the third slider 3125, and the fourth slider 3212 slideably cooperates with the third slide rail 3122.

As a preferred technical solution of this embodiment, the first connecting shaft 3112 extends horizontally, and a first spring component 3113 is also fitted on the first connecting shaft 3112. Two first elastic components 3113 are fitted on each first connecting shaft 3112, symmetrically distributed on two sides of the second slider 3121, acting on the second slider 3121. Preferably, the number of each of the first connecting shaft 3112, the second slide rail 3111, and the second slider 3121 is two, arranged at the upper and lower ends of the first panel 311 and the second panel 312 respectively.

As a preferred technical solution of this embodiment, the second connecting shaft 3123 extends vertically, and a second elastic component 3124 is also fitted on the second connecting shaft 3123. The second elastic component 3124 supports the third slider 3125 upwards from below, providing flexible support for the charging part 4 in the vertical direction. Preferably, multiple second connecting shafts 3123 may be set, preferably an even number, symmetrically arranged between the first panel 311 and the second panel 312, providing stable support for the charging part.

The universal adjustment seat 32 includes a rear end panel 321, an intermediate 322, and a front end panel 323. The aforementioned connecting portion 3211 and the fourth slider 3212 are set on the rear end panel 321 to connect with the sliding platform 31. The intermediate 322 is located between the rear end panel 321 and the front end panel 323, and is hinged with the rear end panel 321 and the front end panel 323. The intermediate 322 may deflect relative to the rear end panel 321 along a first axis. The front end panel 323 may deflect relative to the intermediate 322 along a second axis, with the first axis and the second axis being perpendicular to each other. As such, the front end panel 323 may deflect relative to the rear end panel 321 in two perpendicular directions. Preferably, one of the first axis and the second axis extends in the vertical direction, while the other extends in the horizontal direction.

The charging part 4 is assembled on the universal adjustment seat 32, specifically on the front end panel 323 of the universal adjustment seat 32. The charging part 4 includes a guide component 41 and charging electrodes 42, both of which are assembled on a mounting plate 43, which is assembled on the front end panel 323. Specifically, the guide component 41 is disposed in the middle portion of the mounting plate 43. The charging electrodes 42 include a positive electrode and a negative electrode, which are located on two sides of the guide component 41. In this embodiment, the positive electrode and the negative electrode are located on the upper and lower sides of the guide component 41 respectively. The guide component 41 separates the positive electrode and the negative electrode, increasing the distance between them to ensure safety.

As a preferred technical solution of this embodiment, the guide head of the guide component 41 is set in a V-shape. Correspondingly, the guide groove 201 of the vehicle-end power receiving device 20 is also set in a V-shape, facilitating the insertion between the guide component 41 and the guide groove 201. Copper busbars 202 are set around the guide groove 201 of the vehicle-end power receiving device 20. After the guide component 41 is docked with the guide groove 201, the charging electrodes correspondingly connect with the copper busbars 202.

As a preferred technical solution of this embodiment, the guide component 41 is assembled on the mounting plate 43 through a first connecting rod 411 in a straight sliding manner. A first elastic component 413 is fitted on the first connecting rod 411, and a contact pressure detection switch 414 is set between the guide component 41 and the mounting plate 43. When the contact pressure detection switch 414 is triggered, the robotic arm 2 stops extending. Specifically, the middle portion of the mounting plate 43 protrudes to form a mounting frame 431. One end of the first connecting rod 411 is fixedly connected to the guide component 41, and the other end of the first connecting rod 411 is assembled on the mounting frame 431 through a first linear bearing 412. The first elastic component 413 is fitted on the first connecting rod 411, with the two ends thereof acting on the guide component 41 and the first linear bearing 412 respectively. The contact pressure detection switch 414 is fixed on the mounting frame 431 through a connecting component. A guide pressing component 415 is correspondingly set on the guide component 41. When the guide component 41 moves against the force of the first elastic component 413, the guide pressing component 415 moves towards the contact pressure detection switch 414. When the guide pressing component 415 presses the contact pressure detection switch 414, the contact pressure detection switch 414 is triggered and sends a signal, causing the robotic arm 2 to stop working. Preferably, there are two first connecting rods 411, set in parallel. The first elastic component 413 may be, but is not limited to, a spring.

As a preferred technical solution of this embodiment, the charging electrode 42 further includes a signal electrode and a neutral electrode, which are also located on the upper and lower sides of the guide component 41 respectively. Thus, there are two electrodes distributed on each of the upper and lower sides of the guide component 41. The four electrodes may form a quadrilateral when connected by lines, with the positive electrode and the negative electrode set diagonally. Preferably, the four electrodes are set in central symmetry relative to the guide component 41, with the positive electrode and the negative electrode located on the longer diagonal.

As a preferred technical solution of this embodiment, the charging electrode is assembled on an electrode plate 421. The electrode plate 421 is assembled on the mounting plate 43 through a second connecting rod 423 in a straight sliding manner. A second elastic component 425 is fitted on the second connecting rod 423, and a contact pressure detection structure 426 is set between the electrode plate 421 and the mounting plate 43 to detect the charging pressure. Specifically, the two electrodes located on the upper side of the guide component 41 are assembled on one electrode plate 421, and the two electrodes located on the lower side of the guide component 41 are assembled on another electrode plate 421. Both electrode plates 421 are elastically slidably assembled on the mounting plate 43, and a contact pressure detection structure 426 is set between each electrode plate 421 and the mounting plate 43.

Taking the assembly of one electrode plate 421 as an example, the electrode is assembled on the electrode plate 421 through an insulator 422. One end of the second connecting rod 423 is fixedly connected to the electrode plate 421, and the other end of the second connecting rod 423 is assembled on the mounting plate 43 in a straight sliding manner through a second linear bearing 424. The second elastic component 425 is fitted on the second connecting rod 423, with both ends of the second elastic component 425 acting on the electrode plate 421 and the second linear bearing 424 respectively. The contact pressure detection structure 426 includes a pressure sensor 4261 and a contact component 4262 that cooperate with each other. The pressure sensor 4261 is fixed on the electrode plate 421, and the contact component 4262 is elastically assembled on the mounting plate 43. The pressure sensor 4261 may move with the electrode plate 421, contacting and pressing the contact component 4262 to measure the pressure. Preferably, there are two second connecting rods 423, arranged in parallel vertically, with the contact pressure detection structure 426 located between the two second connecting rods 423. The second elastic component 425 may be, but is not limited to, a spring.

As a preferred technical solution of this embodiment, a contact limit detection switch 427 is also set between the plate electrode 421 and the mounting plate 43. When the contact limit detection switch 427 is triggered, the robotic arm 2 stops extending. Specifically, the contact limit detection switch 427 is assembled on the mounting plate 43, and a charging pressing component 428 is correspondingly assembled on the electrode plate 421. When the charging pressing component 428 moves with the electric plate 421 to press the contact limit detection switch 427, the contact limit detection switch 427 is triggered, sending a signal, and the robotic arm 2 stops extending.

In order to adjust the charging part 4 in the vertical and horizontal directions, the box body 1 may be assembled on the foundation 100 through a bottom adjustment frame 5. The bottom adjustment frame 5 may adjust the position of the box body 1 along the vertical direction and horizontal direction, wherein the horizontal direction is perpendicular to the retracting direction of the robotic arm 2.

As a preferred technical solution of this embodiment, a circuit box 7 is fixed at the rear end of the box body 1 away from the electric sliding door 11. An alarm 8 is assembled on the side wall of the circuit box 7, and a wireless communication module 6 is assembled on the front end side wall of the box body 1.

Based on the above structure, the working process of charging the tractor by the automatic charging device in this embodiment is as follows:

After the tractor is in position, wireless communication is conducted through the communication module of the vehicle-end power receiving device 20 and the wireless communication module 6 of the automatic charging device, sending a charging request signal. The electric sliding door 11 of the box body 1 and the folding double doors of the vehicle-end power receiving terminal open simultaneously. Upon sensing the position, the robotic arm 2 drives the charging part 4 to extend from inside the box body 1, initiating the guiding and positioning process. According to the position error between the vehicle-end power receiving device and the ground-end automatic charging device, the guide component 41 will slowly feed along the surface of the vehicle-end V-shaped guide groove 201, until the guide component 41 enters the guide groove 201 of the vehicle-end power receiving device. The charging electrode 42 gradually contacts the copper busbar 202. At this time, the internal pressure of the four electrodes of the charging contacts electrode 42 and the detection pressure of the contact pressure detection structure 426 are both 0. The robotic arm 2 will continue to drive the charging part 4 to feed slowly until the internal pressure of the electrodes reaches the set value of the charging pressure while also satisfying the detection pressure value of the contact pressure detection structure 426. The signal electrode has an electrical signal conduction, and the system sends a signal indicating that the charging conditions are met and charging may proceed.

After charging is completed, the robotic arm 2 drives the charging part 4 to retract into the box body 1, and the electric sliding door 11 closes by sliding and sealing, ending the entire charging process.

In addition, during the guiding, positioning, and feeding process, if the contact pressure detection structure 426 is damaged, the charging part 4 will continue to feed a small displacement until the charging pressing component 428 touches the contact limit detection switch 427, and the contact limit detection switch 427 sends an electrical signal to stop the motor of the robotic arm 2. If the deviation between the vehicle-end power receiving device 20 and the actual position of the charging part 4 is too large, causing the guide component 41 to be located on the periphery of the guide groove 201, since the detection pressure value of the contact pressure detection structure 426 can never be reached, the robotic arm 2 will drive the charging part 4 to feed forcibly until the charging part 4 overcomes the spring force of the first elastic component 413 and touches the contact pressure detection switch 414, at which point the robotic arm 2 stops feeding, and the alarm 8 starts to sound.

The above description, in conjunction with the accompanying drawings, provides a detailed explanation of the embodiment of the present disclosure. However, the present disclosure is not limited to the above-mentioned embodiment. Within the scope of knowledge of those skilled in the art, various modifications may be made without departing from the spirit of the present disclosure.

1. An automatic charging device, comprising:
a box body;
a robotic arm, the robotic arm comprising a fixed arm and a retractable arm, wherein the fixed arm is assembled inside the box body, a driving screw assembly is assembled between the fixed arm and the retractable arm, the retractable arm is retractable relative to the fixed arm under driving of the driving screw assembly;
a flexible unit;
a charging part, the charging part being assembled at the retractable arm through the flexible unit, under driving of the retractable arm, the charging part is extendable out from the box body for charging; after charging is completed, the charging part retracts into the box body.

2. The automatic charging device according to claim 1, wherein the charging part comprises a guide component and charging electrodes, the guide component and the charging electrodes are both assembled on a mounting plate, the guide component is assembled in a middle portion of the mounting plate, the charging electrodes comprise a positive electrode and a negative electrode, the positive electrode and the negative electrode are located on two sides of the guide component respectively.

3. The automatic charging device according to claim 2, wherein the charging electrodes further comprise a signal electrode and a neutral electrode, the signal electrode and the neutral electrode are located on two sides of the guide component respectively, the positive electrode and the negative electrode are diagonally arranged.

4. The automatic charging device according to claim 2, wherein the guide component is assembled to be linearly slidable through a first connecting rod, a first elastic component is fitted on the first connecting rod, a contact pressure detection switch is disposed between the guide component and the mounting plate, when the contact pressure detection switch is triggered, the robotic arm stops extending.

5. The automatic charging device according to claim 2, wherein the charging electrodes are assembled on an electrode plate, the plate electrode is linearly slidably assembled on the mounting plate through a second connecting rod, a second elastic component is fitted on the second connecting rod, a contact pressure detection structure is disposed between the electrode plate and the mounting plate to detect a charging pressure.

6. The automatic charging device according to claim 5, wherein the contact pressure detection structure comprises a pressure sensor and a contact component, the pressure sensor is assembled on the electrode plate, the contact component is elastically assembled on the mounting plate.

7. The automatic charging device according to claim 5, wherein a contact limit detection switch is further disposed between the electrode plate and the mounting plate, when the contact limit detection switch is triggered, the robotic arm stops extending.

8. The automatic charging device according to claim 1, wherein a sliding assembly is further disposed between the fixed arm and the retractable arm, the sliding assembly is set parallel to the driving screw assembly.

9. The automatic charging device according to claim 1, wherein the box body is assembled through a bottom adjustment frame, the bottom adjustment frame is able to adjust a position of the box body along a vertical direction and a horizontal direction, the horizontal direction is perpendicular to a retracting direction of the robotic arm.

10. The automatic charging device according to claim 1, wherein the flexible unit comprises a sliding platform and a universal adjustment seat, the universal adjustment seat is slidably assembled on the robotic arm through the sliding platform, the charging part is assembled on the universal adjustment seat.

11. The automatic charging device according to claim 3, wherein the guide component is assembled to be linearly slidable through a first connecting rod, a first elastic component is fitted on the first connecting rod, a contact pressure detection switch is disposed between the guide component and the mounting plate, when the contact pressure detection switch is triggered, the robotic arm stops extending.

12. The automatic charging device according to claim 3, wherein the charging electrodes are assembled on an electrode plate, the plate electrode is linearly slidably assembled on the mounting plate through a second connecting rod, a second elastic component is fitted on the second connecting rod, a contact pressure detection structure is disposed between the electrode plate and the mounting plate to detect a charging pressure.

13. The automatic charging device according to claim 12, wherein the contact pressure detection structure comprises a pressure sensor and a contact component, the pressure sensor is assembled on the electrode plate, the contact component is elastically assembled on the mounting plate.

14. The automatic charging device according to claim 12, wherein a contact limit detection switch is further disposed between the electrode plate and the mounting plate, when the contact limit detection switch is triggered, the robotic arm stops extending.
